(19) United States
(12) Patent Application Publication
(10) Pub. No.: US 2002/0144131 A1
(43) Pub. Date: Oct. 3, 2002

(54) Method for the secure distribution of electronic media

(76) Inventor: Simon Alan Spacey, London (GB)

Correspondence Address: SIMON ALAN SPACEY, SUITE 94, 2 LANSDOWNE ROW, LONDON, WIJ GHL, GB

(21) Appl. No.: 09/908,706

(22) Filed: Jul. 20, 2001

(30) Foreign Application Priority Data
Apr. 2, 2001 (GB) 0108201.5

(51) Int. Cl. H04K 1/00

(52) U.S. Cl. 713/189

(57) ABSTRACT

This invention presents a method or system for the secure distribution of electronic media through a network. The method is unique in that it protects a distributor's license and copyrights even when distributing random-access electronic media such as software and books. To achieve this benefit, the invention uses 3 components: a Licence Media Service (LMS), a Client Log-in Component (CLC) and a secure Client Instantiation Component (CIC). The client uses the CLC to identify itself to the LMS and request the media. The LMS validates the user and sends only allowed media components back to the client. The CLC then passes these components on to the CIC which instantiates them directly in client memory, without first saving them to disk, drastically reducing the risk of piracy as the media is never stored per-sea on the client machine.

### BACKGROUND OF THE INVENTION

Piracy has plagued the creative industries since their beginning. The software, book, music and film industries loose billions of dollars each year through illegal copying and distribution of their works. Copyright law is aimed to protect these industries, but with the advent of electronic distribution, the Internet and home CD-RW and DVD-RAM machines, copying has become more insidious and all pervasive than ever before. In the past, piracy was a capital-intensive process, requiring weeks of preparation in a dedicated piracy studio, today piracy is built into every home.

With every home becoming a potential centre for piracy, the job of enforcing license and copyright law has become impractical. This problem has arguably contributed to the rapid growth of the GNU and Free Software movements with both users and developers accepting the motto: “. . . if you can't stop it, why even try!”.

The present invention seeks to reduce the impact of media piracy on the creative industries and in particular the software industry. It does this by introducing a new method of electronic media distribution using a network (such as the Internet) where the media is never held in a copyable format on a user's machine but can still be used to its full potential.

### BRIEF SUMMARY OF THE INVENTION

It is an object of the present invention to provide a method for the secure distribution of electronic media through a network that reduces the risk of piracy. The system as presented works with all electronic media formats including music and film but is particularly suited to instantiable, file-based, electronic media such as software where parts of the media must remain in client memory and may be accessed at random.

It is a second object of the present invention to provide a simple method for the electronic distribution of software and other electronic media through a network The method, according to the invention, reduces cost and time to market and allows new types of pay-peruse licensing agreements to be enforced.

These and other objects, advantages and features of the present invention are provided by a new method for the delivery and use of the electronic media through a network. The method comprising at least 3 logical components:

1. A License Media Service component (LMS). The LMS component holds the media in a distributable form and validates requests from clients for the media. Once a client's request has been validated against the distributor's license criteria, the LMS sends the requested media items to the client through the network.

2. A Client Log-in Component (CLC). This component is responsible for connecting to the LMS through the network, supplying a request for media and validation parameters and receiving the electronic media back through the network.

3. A Client Instantiation Component (CIC). The CIC is responsible for instantiating the returned electronic media in a form ready for users to interact with. An example of such instantiation is where the distributed media is Java software class files and these are instantiated as runnable objects by the instantiation component directly in memory. This direct instantiation into volatile memory avoids storing the media on disk or other non-volatile storage where it could be copied. Media instantiation is different in character to merely streaming the media to a client application, using it once and then discarding it as the instantiated object may remain in memory and be randomly accessible as with a software component. Instantiation may require runtime lining and address mapping the distributed media with elements of the operating system or other applications depending on the media type.

In a method according to the invention, a generic “stub” is installed on a client machine containing both the CLC and CIC components. The stub allows the instantiation and use of different media services delivered by the networked LMS depending on the user request and distributed on an as-needed basis. This reduces the amount of non-volatile storage the client needs. Additionally, as each service is distributed “as-needed”, there is little or no risk of miss-configuration of the media service as it is distributed fresh each time to the client easing the burden of administration. The client stub may also provide generic functionality such as graphics and sound drivers that cross media boundaries as is the case with the preferred Java embodiment.

In a second method according to the invention, the LMS validates the user based on any combination of username, password, source address, software and hardware identification and other information as supplied through the CLC or request. The LMS then delivers the appropriate licensed media for the user.

In a further method of the invention, the CLC and CIC components of the client stub are optionally checked by the LMS to see if they have been tampered with before media is sent to the client. If this check were not performed, inventive pirates would be able to change (reengineer) the CLC or CIC components to have them save the media to disk in a copiable format instead of directly instantiating it in memory, this would circumvent the protection afforded by the system. In the preferred embodiment, this checking is performed by the LMS optionally sending a checking executable to the client when the CLC tries to log-in. This executable must be run by the client and generates and returns a hash of the CLC and CIC component files for validation by the LMS.

In the preferred embodiment of the invention the LMS transfers the media to the CLC over a secure encrypted connection and the CLC transfers the instantiable media to the CIC using shared memory or other highly volatile storage, rather than storing the media temporarily on disk. The CIC can then instantiate the media directly in its own process or pass it to a running process perhaps again through shared memory or through a application secured virtual file system.

In another embodiment of the system according to the invention the CLC stores the media temporarily on the client machine or a network file store for a CIC to instantiate. The advantage of this embodiment is that only a single network transfer is required for the media from the LMS and, provided the media is not updated, the same stored encrypted files can be used by many CIC instances potentially across many clients on a LAN. In this embodiment, the storage is preferably in an encrypted format and the file decryption key is needed by each CIC component.

In yet another embodiment of the system according to the invention the media is passed directly to the CIC from the LMS instead of being transferred through the CLC. This has the advantage of removing the need for shared memory and may be implemented through an FTP like control and data channel (CLC and CIC channel), a combined functionality CLC+CIC component, a dependant dual connect or a well known CIC port or similar.

### BRIEF DESCRIPTION OF THE DRAWINGS

Embodiments of the invention will now be disclosed, for example purposes only and without limitation, with reference to the accompanying drawings, in which:

FIG. 1 shows the network architecture of the preferred embodiment.

FIG. 2 shows the deployment architecture of the LMS, CLC and CIC components in the preferred embodiment.

FIG. 3 shows the process for distributing a simple Java software application from the LMS to the client and starting it assuming no errors.

FIG. 4 shows a simple license database structure.

### DETAILED DESCRIPTION

A preferred embodiment of the invention will now be disclosed, without the intention of a limitation, in a computer system for the purpose of delivering Java application software to users. Java is a powerful programming language but many professional commercial programmers have shied away from using it because it is too easy to de-compile and recover the Java source code from distributable Java byte-code classes and programs. This ease of de-compilation means that the secrets of commercial software products can be obtained and that licensing measures imbedded into software easily circumvented if that software is written in Java. By using the invention as disclosed in this embodiment the Java software class files are never stored in a copyable format on the user's machine and thus can not be read as files by a Java de-compilation program but can still be used without limitation.

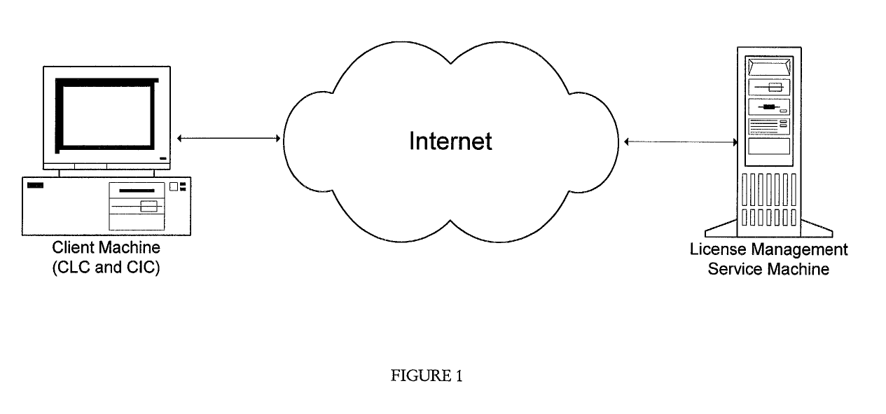

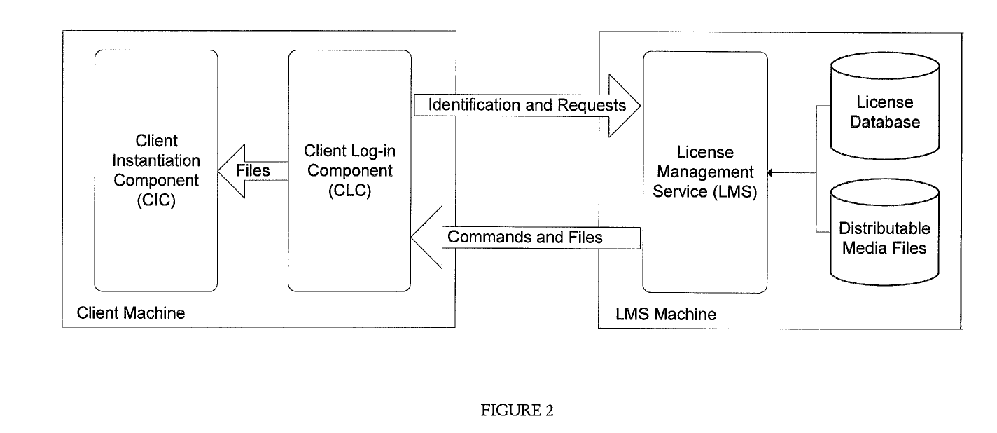

FIGS. 1 and 2 shows the architecture of the preferred embodiment. In this preferred embodiment, the CLC and CIC are implemented in software and reside on the same client machine. The LMS is a server component located on a networked machine on the Internet that the client machine can access.

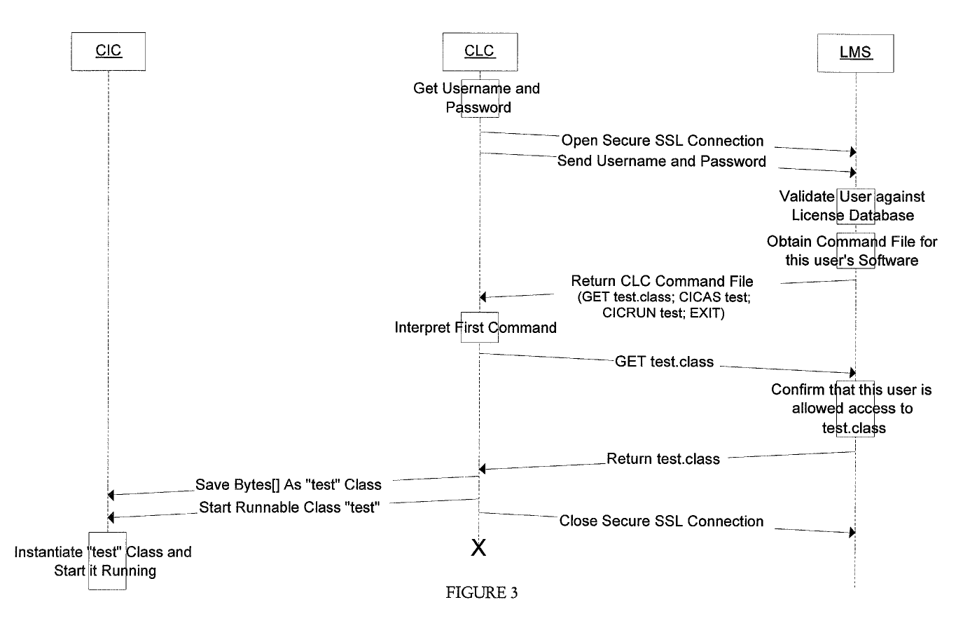

FIG. 3 shows the process of distributing a simple (single class) Java application from the IMS to the client and starting it. The main stages of this process are:

1. The LIMS service is started and waits for client requests from the Internet.

2. The user starts-up the CLC on the client machine.

3. The user enters validation credentials into the CLC. In the preferred embodiment, these credentials are simply a username and password.

4. The CLC opens a secure network connection to the LMS. In the preferred embodiment this is an SSL client connection over TCP/IP.

5. The CLC sends the username and password over the secure connection to the LMS.

6. The LMS validates the username and password against its license database and, in the preferred embodiment, obtains a control file for the Java application the user has licensed. The control file consists of a set of instructions that that the CLC must interpret in sequence to complete the distribution process.

7. The LMS returns the control file to the CLC through the still-open, now validated, secure SSL connection.

8. The CLC executes each command in the command file in sequence. Typical commands are to request a specific component of the Java application from the LMS through the validated secure connection and pass the returned class file to the CIC component for storage in an instantable class hash. The command file typically ends with the name of the class that should be started first in the CIC and an exit command

9. The secure, validated, CLC to LMS connection is terminated by the CLC after the command file is completed or when an EXIT command is interpreted. The CLC process then ends leaving the CIC as a separate operating system process running the Java software.

In accordance with the present invention, the CLC uses an encrypted secure connection to communicate with the LMS to prevent network “sniffers” from obtaining either the user credentials or the returned instantiable Java classes. In the preferred embodiment, encryption protection is provided through the use of Secure Socket Layer (SSL) communications.

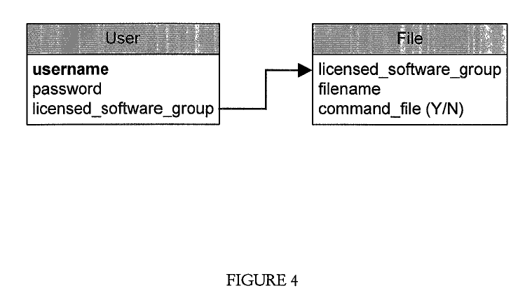

In a first embodiment of the invention, a simple license database is used by the LMS to validate users. This database has two purposes. Firstly, it holds the relation between usernames and passwords so that users can be validated. Secondly, it holds the relation between validated usernames and the software files they are allowed to request from the LMS. This allows the same LMS to serve different Java applications to different users depending on their Licensed Software Group. The database can be relational in format and may contain at least a user and a file table an example for which is provided in FIG. 4.

In step 6 above, the username is validated against the password in the user table, the correct Licensed Software Group found and associated with the network connection by the LMS and finally, the command file name/address is located from the file table for the users Licensed Software Group. There should be only one command file per Licensed Software Group (this could change if each users' settings are stored on the LMS) and this strictly means that there should be a separate License Software Group/Command File join table between the user and file tables, but for simplicity, a flag is used in the file table here to mark the file that contains the CLC interpretable commands for a Licensed Software Group.

Once the LMS has validated the user, identified their licensed software group and located the command file for that group, the LMS reads the correct command file and sends it through the secure connection back to the client CLC component. The command file is preferably located on the LMS machine on the Internet as are the other files in the file table, but this is implementation dependant.

In a first embodiment, the command file has only a very limited set of commands and transfers files into a local temporary buffer “unnamed” before saving the file media to its ultimate destination as a second, separate command. Example commands in this first embodiment are:

1. GET <file>. The CLC sends a request for the file named <file> to the LMS server through the open, validated, secure network connection. The LMS checks to confirm that the validated user is allowed to access this file by looking-up the file and user's Licensed Software Group in the file table of the license database. If the user is allowed to access the file, the LMS sends it back preceded by an OK header and the CLC stores the file by overwriting its file temporary buffer. Otherwise, the LMS sends an error header back to the CLC and may terminate the secure connection with the CLC immediately thereafter.

2. STOREAS <path and name>. Stores the contents of the CLC's temporary storage buffer to the local operating system file named in the argument. By default, the file is overwritten. If the CLC temporary file buffer is empty (a malformed command) or the operating system file locked, the CLC may terminate with an appropriate warning to the user.

3. RUN <command and parameters>[\wait]. Runs a separate operating system shell command. This command can be used to run executables, delete files or update stub components.

4. CICAS <class name>Transfers the contents of the CLC's temporary storage buffer to the CIC as a class named <class name>.

5. CICRUN <class name>. The CLC tells the CIC to start the class it has previously transferred to it named <class name>. This class is usually a top-level Java class and may invoke methods of other classes previously loaded into the CIC's class buffer by the CLC.

6. EXIT the CLC program terminates. All remaining temporary buffer content is deleted and the validated connection to the LMS is closed.

With only these 6 limited CLC commands it is possible to:

1. Update the client stub by transferring a zipped executable and then running it on the client. The executable can unpack compressed update files and overwrite the files of the CLC and CIC stub on the client. An example CLC command file would be: GET update.exe; STOREAS c:\temp\update.exe; RUN c:\temp\update.exe; EXIT

2. Ensure that the client stub CLC and CIC components have not been tampered with before transferring any licensed Java software. An example CLC command file would be:

GET check.exe; STOREAS c:\temp\check.exe; RUN “c:\temp\check.exe unique cookie”

3. Securely obtain and run Java software classes. An example CLC command file would be:

GET java.class; CICAS runnable_class; CICRUN runnable_class; EXIT

In the preferred embodiment, the client stub CLC and CIC components are validated by transferring a checking executable to the client and starting it with a unique cookie. The executable calculates the hash codes of all of the CLC and CIC component software and dependencies to ensure that they have not been tampered with. In the first embodiment this is performed with the secure hash (sha1) algorithm.

The executable then returns the hashes to the LMS along with the unique cookie. The LMS requires the unique cookie to be returned to it to confirm that the CLC and CIC hashes are from the same executable it sent to the client and to prevent malicious clients reverse-engineering the hashing software.

In the preferred embodiment, the hash executable is sent to the client machine on every login, but it is understood that checking client CLC and CIC stubs at random may be more appropriate. Where checking is performed, the check executable is the first thing that must be requested by the client after the command file had been sent to it by the LMS. After that the LMS suspends the transfer of any other files requested by the CLC until it receives and verifies the CLC and CIC hashes generated by the check executable. These hashes will be received on a new SSL connection at the LMS but with the unique cookie, it is possible for the LMS to resume this CLC's connection.

It only remains now to discuss the CLC to CIC component interaction and the instantiation process in more detail. For a first preferred embodiment, the CLC and CIC functionality is provided in a single as Java application stub installed on the client. This simplifies the instantiation of the delivered Java class files greatly. The combined CLC and CIC Java application is started in a new JVM by the user clicking on an icon or otherwise. The CLC part of the application collects user log-in information, validates through a secure connection with the LMS, gets the command file, retrieves each Java class file into temporary storage and then passes those storage bytes on to the CIC with the name of the corresponding Java class.

The CIC part of the application can be an implementation of the SecureClassLoader or ClassLoader Java interfaces. The CIC casts and stores the passed temporary storage bytes as a Java class file in a private object hash, indexed on the class name specified in the CICAS command from the CLC. When the CLC finishes loading all the classes through the secure LMS connection, it sends a CICRUN command to the CIC SecureClassLoader implementation class with the name of the route runnable class for the licensed Java application. The CIC then retrieves this class from its private object hash by name, casts it to a Java runnable and calls the run method. Since the Java media's root class is started from a SecureClassLoader implementation, any classes required for the execution of the root application class will be requested through the same CIC by the JVM and the CIC will return objects based on the classes it has been fed from the CLC.

As an alternative to a 100% pure Java implementation, a second embodiment implements the CLC functionality as a separate native operating system executable. This has the advantage of hiding the internal workings of the CLC log-in and validation component as this would otherwise be distributed to clients in a Java file that could be reverse-engineered. The only drawback with this approach is one of implementation difficulty as the CIC is still in Java and the CLC and CIC must now communicate through Java Native Interface or similar.

In a modification of the above, the CLC is an executable and transfers class files and commands to a Java based CIC using UDP or TCP/IP sockets on the client machine on a known port. This means that the same CIC can be used for multiple CLC log-in sessions and common classes shared amongst Java applications without the need for reloading them. This obviously saves resources, but has a drawback in that it is now necessary for the CLC to validate that the CIC has not been tampered with before it passes it any instantiable classes.

We claim:

1. a method for the delivery of electronic media through a network, characterised by:
a) A Licence Media Service (LMS) that validates client requests for media and returns requested media to clients
b) A Client Log-in Component (CLC) that logs into the LMS and requests media from it
c) A Client Initialisation Component (CIC)

2. A method according to claim 1, wherein:
a) The Licence Media Service (LMS) is started on a networked machine addressable by the CLC client
b) The CLC and CIC reside on the same or different client machines
c) The CLC, sends identification or log-in information to the LMS
d) The LMS verifies the client's identity and its requests for specific media against an optional license database and returns media to the client through a network connection
e) The CLC passes the media on to the CIC for instantiation
f) The CIC instantiates the media directly in memory or through a secure virtual file system

3. a method according to claim 1 or 2, wherein said media includes instantiable media such as electronic files or software that can be used out-of-sequence or require random access during use and are not necessarily suitable for “streamed” delivery.

4. a method according to claim 3, wherein said instantiable media includes Java class files.

5. A method as described in claim 1 or 2 wherein, the LMS delivers different media to the client depending on the client identification information.

6. a method according to claim 1 or 2, wherein said CLC and CIC work together to instantiate the delivered electronic media or software directly in client memory for users to interact with, without recourse to storing the delivered media in temporary or other file storage at the client.

7. A method according to any of claims 1 to 5, wherein said CLC stores the delivered media in encrypted files whose access key is known to the CIC.

8. A method according to any of the previous claims, wherein the LMS validates and transfers the requested media to the CLC over a secure connection.

9. A method according to claim 8, wherein said secure connection is an encrypted network connection such as that provided by Secure Socket Layer over TCP/IP.

10. A method according to any of the previous claims where the CLC or CIC client components are verified before media is transferring from the LMS with the use of a hashing or other fingerprint algorithm.

11. A method substantially as herein described with reference to FIGS. 1 to 4 of the accompanying drawings.

12. Use of any of the methods of claims 1 to 10.

13. Apparatus configured to perform any one of the methods of claims 1 to 10.

14. Means to perform any of the methods of claims 1 to 10.
